(19) United States
(12) Patent Application Publication
(10) Pub. No.: US 2010/0080438 A1
(43) Pub. Date: Apr. 1, 2010

(54) Radiation image diagnosing system

(75) Inventors: Tomoyoshi Nishimura, Tokyo (JP); Jun Enomoto, Kanagawa-ken (JP); Hirofumi Sawada, Minami-ashigara-shi (JP); Sadato Akahori, Odawara-shi (JP); Eiichi Kanagawa, Minami-ashigara-shi (JP); Yasunori Ohta, Yokohama-shi (JP); Noriaki Ida, Minami-ashigara-shi (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/585,929

(22) Filed: Sep. 29, 2009

(30) Foreign Application Priority Data
Sep. 30, 2008 (JP) 2008-254256
Aug. 13, 2009 (JP) 2009-187695

(51) Int. Cl. G06K 9/00

(52) U.S. Cl. 382/132

(57) ABSTRACT

A radiation image diagnosing system includes a tomosynthesis image capturing assembly for acquiring the data of a plurality of tomosynthetic sectional images. The acquired data of the tomosynthetic sectional images are processed to reconstruct a shift-and-add image by a shift-and-add processor. The acquired data of the tomosynthetic sectional images are also processed to reconstruct an FBP image by an FBP processor. The shift-and-add image and the FBP image are displayed parallel to each other on a display unit.

### CROSS-REFERENCE TO RELATED APPLICATIONS

This application is based upon and claims the benefit of priority from Japanese Patent Application No. 2008-254256 filed on Sep. 30, 2008 and Japanese Patent Application No. 2009-187695 filed on Aug. 13, 2009 in the Japanese Patent Office, of which the contents are incorporated herein by reference.

### BACKGROUND OF THE INVENTION

1. Field of the Invention

The present invention relates to a radiation image diagnosing system including a tomosynthesis image capturing assembly, and more particularly to a radiation image diagnosing system which is capable of displaying parallel sectional images that have been reconstructed according to different processes from a plurality of sectional images acquired by a tomosynthesis image capturing assembly.

2. Description of the Related Art

Tomosynthesis is known in the art as a process of capturing sectional radiation images. According to tomosynthesis, a radiation is applied from a radiation source to a subject at different angles, and the radiation that has passed through the subject is detected by a radiation conversion panel to capture a plurality of sectional images (tomosynthetic sectional images). The captured tomosynthetic sectional images are processed to reconstruct sectional images (reconstructed sectional images) at desired sectional positions (slice heights).

Existing processes of reconstructing tomosynthetic sectional images include a shift-and-add process (see, for example, Japanese Laid-Open Patent Publication No. 2001-017419 and U.S. Patent Application Publication No. 2005/0213701) and a filtered back projection (FBP) process (see, for example, U.S. Patent Application Publication No. 2002/0154728).

There has been proposed in the art a process of combining and displaying a plurality of types of sectional images generated by radiation capture (U.S. Patent Application Publication No. 2006/0262118).

The shift-and-add process and the FBP process are based on different image reconstructing principles. Therefore, sectional images reconstructed according to the shift-and-add process and the FBP process have different resolutions and contrasts in the sectional direction. At present, either of these reconstructing processes has no absolute advantage over the other. Since doctors who are handling reconstructed radiation images are uncertain about which one of the reconstructing processes produces better reconstructed radiation images, they find it difficult to diagnose the reconstructed radiation images efficiently. If a doctor has not become accustomed to sectional images, then it is helpful for the doctor to compare, for diagnosis, a well-known simple X-ray image that can be acquired by a tomosynthesis image capturing apparatus and a reconstructed sectional image which are displayed together.

### SUMMARY OF THE INVENTION

It is an object of the present invention to provide a radiation image diagnosing system which allows for efficient diagnoses.

According to the present invention, there is provided a radiation image diagnosing system comprising a tomosynthesis image capturing assembly for applying a radiation from a radiation source to a subject at a plurality of different angles, detecting the radiation which has passed through the subject with a radiation conversion panel, and capturing a plurality of tomosynthetic sectional images, a shift-and-add processor for processing the tomosynthetic sectional images to reconstruct a shift-and-add image according to a shift-and-add process, a filter back projection (FBP) processor for processing the tomosynthetic sectional images to reconstruct an FBP image according to an FBP process, a display unit, and a display controller for controlling the display unit to display the shift-and-add image and the FBP image parallel to each other thereon.

With the above arrangement, the shift-and-add image and the FBP image are displayed parallel to each other on the display unit. Since the doctor who uses the radiation image diagnosing system can view both the shift-and-add image and the FBP image at one time, the doctor can diagnose the subject efficiently.

The radiation image diagnosing system may further comprise a simple X-ray image capturing unit for plain radiography, arranged to acquire a simple X-ray image, and the display controller may control the display unit to display the simple X-ray image and at least one of the shift-and-add image and the FBP image parallel to each other thereon.

Therefore, the simple X-ray image and at least one of the shift-and-add image and the FBP image can be displayed parallel to each other on the display unit. As the doctor can view the simple X-ray image and at least one of the shift-and-add image and the FBP image, the doctor can diagnose the subject efficiently.

The display controller may associate coordinates of the simple X-ray image and coordinates of the at least one of the shift-and-add image and the FBP image, control the display unit to display a frame an area of interest in the displayed simple X-ray image, and control the display unit to display the shift-and-add image or the FBP image which corresponds to the displayed simple X-ray image within the frame of the area of interest.

Consequently, the shift-and-add image or the FBP image can be displayed in the area of interest within the displayed simple X-ray image. Therefore, the shift-and-add image or the FBP image can be displayed in the area of interest against the background of the displayed simple X-ray image. As a result, the doctor can diagnose the subject with increased convenience.

Preferably, the display controller performs an image correcting process separately on the shift-and-add image and the FBP image. The radiation image diagnosing system is thus capable of handling images where the image correcting process is effective with respect to only one of the shift-and-add image and the FBP image.

The image correcting process may be a gain adjusting process (sensitivity correcting process), an offset adjusting process (gradation correcting process), an edge emphasizing process (frequency emphasizing process), etc.

When the display controller enlarges or reduces one of the shift-and-add image and the FBP image or changes a display range of the one of the shift-and-add image and the FBP image, the display controller may also enlarge or reduce the other of the shift-and-add image and the FBP image or change a display range of the other of the shift-and-add image and the FBP image. Since the radiation image diagnosing system can display the shift-and-add image and the FBP image in relation with each other, the doctor can easily compare the shift-and-add image and the FBP image with each other. Therefore, the doctor can diagnose the subject more efficiently.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a block diagram of a radiation image diagnosing system according to an embodiment of the present invention;

FIG. 2 is a flowchart of a process for carrying out a tomosynthesis image capturing mode and a simple X-ray image capturing mode performed by the radiation image diagnosing system according to the embodiment of the present invention;

FIG. 3 is a flowchart of a processing sequence of an image processor of the radiation image diagnosing system according to the embodiment of the present invention;

FIG. 4 is a view showing an example of images displayed by the radiation image diagnosing system according to the embodiment of the present invention; and

FIG. 5 is a view showing another example of images displayed by the radiation image diagnosing system according to the embodiment of the present invention.

### DESCRIPTION OF THE PREFERRED EMBODIMENTS

### A. Embodiment

### 1. Configuration of Radiation Image Diagnosing System 10

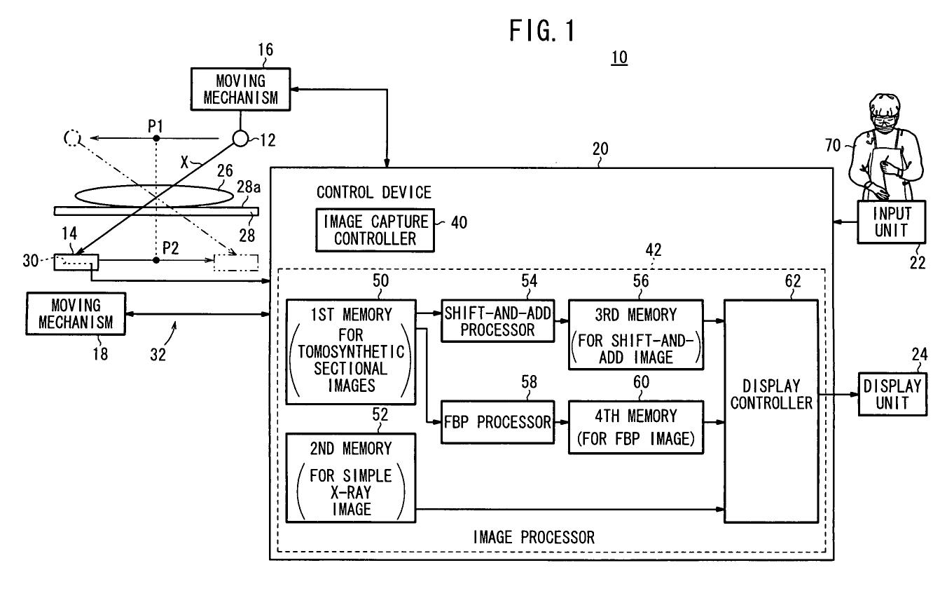

FIG. 1 shows in block form a radiation image diagnosing system 10 according to an embodiment of the present invention.

As shown in FIG. 1, the radiation image diagnosing system 10 comprises a radiation source 12, a cassette 14, a first moving mechanism 16, a second moving mechanism 18, a control device 20, an input unit 22, and a display unit 24.

The radiation source 12 emits a radiation X at a prescribed dosage in response to a command from the control device 20. The cassette 14 houses a radiation conversion panel 30 therein. The radiation conversion panel 30 detects the radiation X that has been emitted from the radiation source 12 and passed through a subject 26 (patient) lying on a support surface 28a of an image capturing base 28, and converts the detected radiation X into radiation image information. The radiation conversion panel 30 outputs the converted radiation image information to the control device 20. The first moving mechanism 16 moves the radiation source 12 in response to a command from the control device 20. The second moving mechanism 18 moves the cassette 14 in response to a command from the control device 20. The radiation source 12, the radiation conversion panel 30, the first moving mechanism 16, the second moving mechanism 18, and the control device 20 jointly make up a tomosynthesis image capturing assembly 32 according to the present embodiment.

The tomosynthesis image capturing assembly 32 is capable of operating in both a tomosynthesis image capturing mode and a simple X-ray image capturing mode. The tomosynthesis image capturing mode is a mode for acquiring the data of a plurality of sectional images for tomosynthesis (tomosynthetic sectional images) to be processed to reconstruct a sectional image. The simple X-ray image capturing mode is a mode for acquiring a well-known simple X-ray image with the tomosynthesis image capturing assembly 32. Since the tomosynthesis image capturing assembly 32 is capable of operating in the simple X-ray image capturing mode, it also functions as a simple X-ray image capturing assembly. In the tomosynthesis image capturing mode, a plurality of tomosynthetic sectional images that have been acquired are processed to reconstruct a sectional image. The dosage of the radiation X that is applied to acquire the data of a single tomosynthetic sectional image is set to a level which is lower than the dosage of the radiation X that is applied to acquire the data of a single sectional image.

The control device 20 includes an image capture controller 40 and an image processor 42.

The image capture controller 40 operates the radiation source 12, the radiation conversion panel 30, the first moving mechanism 16, and the second moving mechanism 18 to control the tomosynthesis image capturing mode and the simple X-ray image capturing mode. Specifically, in the tomosynthesis image capturing mode, the image capture controller 40 moves the radiation source 12 and the radiation conversion panel 30 synchronously in respective opposite horizontal directions with the subject 26 interposed therebetween while the direction in which the radiation source 12 applies the radiation X is being held approximately in alignment with a line interconnecting the center of the radiation source 12 and the center of the radiation conversion panel 30. While the radiation source 12 and the radiation conversion panel 30 are being moved synchronously, the image capture controller 40 instructs the radiation source 12 to emit the radiation X and also reads the radiation image information (the data of tomosynthetic sectional images) acquired by the radiation conversion panel 30.

In the simple X-ray image capturing mode, the image capture controller 40 instructs the radiation source 12 to emit the radiation X at the dosage required to obtain the data of a simple X-ray image and also reads the radiation image information (the data of a simple X-ray image) acquired by the radiation conversion panel 30. In the present embodiment, the tomosynthesis image capturing assembly 32 operates in the simple X-ray image capturing mode when the line interconnecting the center of the radiation source 12 and the center of the radiation conversion panel 30 is perpendicular to the support surface 28a of the image capturing base 28.

The image processor 42 processes the data of tomosynthetic sectional images and the data of a simple X-ray image, and outputs the processed data to the display unit 24. The image processor 42 comprises a first memory 50, a second memory 52, a shift-and-add processor 54, a third memory 56, an FBP processor 58, a fourth memory 60, and a display controller 62.

The first memory 50 stores the data of tomosynthetic sectional images acquired in the tomosynthesis image capturing mode. The second memory 52 stores the data of a simple X-ray image acquired in the simple X-ray image capturing mode. The shift-and-add processor 54 processes the data of tomosynthetic sectional images according to a shift-and-add process to reconstruct the data of a shift-and-add image, and outputs the data of the reconstructed shift-and-add image. The third memory 56 stores the data of the shift-and-add image output from the shift-and-add processor 54. The FBP processor 58 processes the data of tomosynthetic sectional images according to an FBP process to reconstruct the data of an FBP image, and outputs the data of the reconstructed data of the FBP image. The fourth memory 60 stores the data of the FBP image output from the FBP processor 58. The display controller 62 processes the data of the simple X-ray image stored in the second memory 52, the data of the shift-and-add image stored in the third memory 56, and the data of the FBP image stored in the fourth memory 60, and control the display unit 24 to display the simple X-ray image, the shift-and-add image, and the FBP image based on the processed data thereof, as described in detail later.

The input unit 22 serves to enter commands from a doctor 70 for the tomosynthesis image capturing mode. The input unit 22 may comprise operating buttons, a key board, a mouse, etc., for example. The display unit 24 displays images based on data output from the control device 20.

Basic configurational details for the tomosynthesis image capturing mode may be the same as those disclosed in U.S. Patent Application Publication No. 2005/0213701.

### 2. Process for Carrying Out the Tomosynthesis Image Capturing Mode and the Simple X-Ray Image Capturing Mode

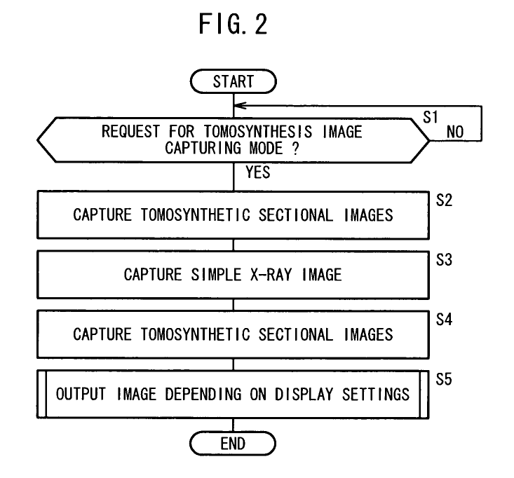

A process for carrying out the tomosynthesis image capturing mode and the simple X-ray image capturing mode using the radiation image diagnosing system 10 according to the present embodiment will be described below. FIG. 2 is a flowchart of the process for carrying out the tomosynthesis image capturing mode and the simple X-ray image capturing mode.

In step S1 shown in FIG. 2, the image capture controller 40 of the control device 20 determines whether the doctor 70 has entered a request for the tomosynthesis image capturing mode into the input unit 22 or not. If the doctor 70 has not entered a request for the tomosynthesis image capturing mode into the input unit 22 (S1: NO), then step S1 is repeated. If the doctor 70 has entered a request for the tomosynthesis image capturing mode into the input unit 22 (S1: YES), then the image capture controller 40 starts the tomosynthesis image capturing mode in step S2. Specifically, the image capture controller 40 actuates the first moving mechanism 16 and the second moving mechanism 18 to move the radiation source 12 and the radiation conversion panel 30 synchronously in respective opposite horizontal directions with the subject 26 interposed therebetween, and instructs the radiation source 12 to emit the radiation X. The radiation X is applied to the subject 26, passes through the subject 26, and is detected by the radiation conversion panel 30, which converts the detected radiation X into radiation image information (the data of tomosynthetic sectional images).

In the tomosynthesis image capturing mode, when the radiation source 12 reaches a position (perpendicular position P1) which is perpendicular to the support surface 28a of the image capturing base 28, and the radiation conversion panel 30 reaches a corresponding position (perpendicular position P2) that is vertically aligned with the perpendicular position P1, the image capture controller 40 controls the radiation source 12 to increase the dosage of the emitted radiation X and starts the simple X-ray image capturing mode to acquire the data of a simple X-ray image in step S3.

In step S4, the image capture controller 40 resumes the tomosynthesis image capturing mode to acquire the data of tomosynthetic sectional images.

When the tomosynthesis image capturing mode is finished, the image processor 42 of the control device 20 displays at least one of a simple X-ray image, a shift-and-add image, and an FBP image on the display unit 24 according to preset display settings, as described below.

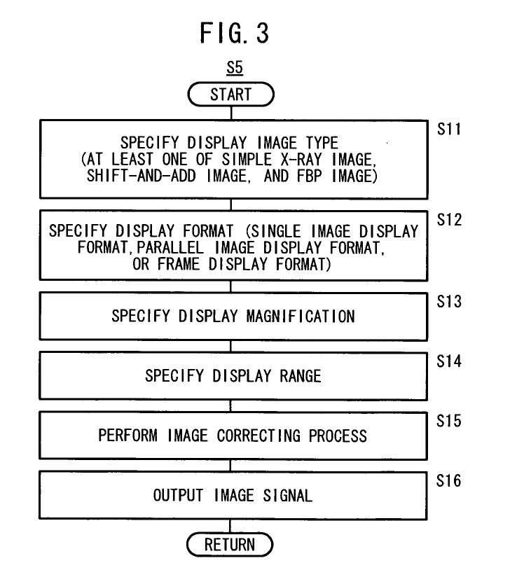

FIG. 3 is a flowchart of a processing sequence of the image processor 42. In the present embodiment, the preset display settings for the display unit 24 include a display image type, a display format, a display magnification, a display range, and an image correcting process. These display settings are selected prior to the tomosynthesis image capturing mode, and can be changed during or after the tomosynthesis image capturing mode.

In step S11 shown in FIG. 3, the image processor 42 specifies a display image type. The display image type represents an image to be displayed on the screen of the display unit 24. The display image type may represent at least one of a simple X-ray image, a shift-and-add image, and an FBP image. Specifically, one or two or all of a simple X-ray image, a shift-and-add image, and an FBP image are selected to be displayed on the screen of the display unit 24. An image or images depending on the preset display image type are output to the display controller 62. Specifically, if a shift-and-add image is selected, then the shift-and-add processor 54 reads the data of the tomosynthetic sectional image from the first memory 50, and processes the read data to reconstruct the data of a shift-and-add image. The reconstructed data of the shift-and-add image are then temporarily stored in the third memory 56, and thereafter output to the display controller 62. If an FBP image is selected, then the FBP processor 58 reads the data of the tomosynthetic sectional image from the first memory 50, and processes the read data to reconstruct the data of an FBP image. The reconstructed data of the FBP image are then temporarily stored in the fourth memory 60, and thereafter output to the display controller 62. If a simple X-ray image is selected, then the data of the simple X-ray image are read from the second memory 52 to the display controller 62.

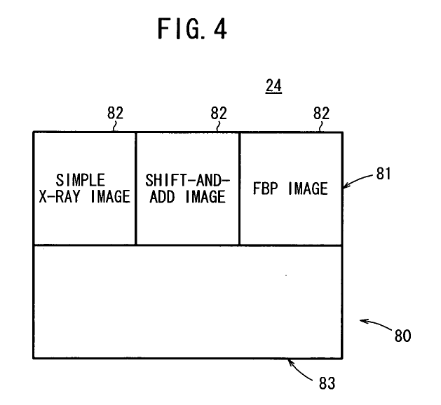

In step S12, the image processor 42 specifies a preset display format. The display format may be a single image display format, a parallel image display format, or a frame display format. The single image display format is a format for displaying a single image alone. The parallel image display format is a format for displaying two or three images parallel to each other. If two images are to be displayed parallel to each other according to the parallel image display format, then it is possible to select images to be displayed and positions where they are to be displayed. If three images are to be displayed parallel to each other according to the parallel image display format, then it is possible to select positions where they are to be displayed. FIG. 4 shows three images displayed parallel to each other on the display unit 24 according to the parallel image display format. Specifically, a simple X-ray image, a shift-and-add image, and an FBP image are displayed parallel to each other respectively in three image display areas 82 divided from an image display area 81 on a screen 80 of the display unit 24. The display area of the screen 80 except for the image display area 81 is a character information display area 83 for displaying character information.

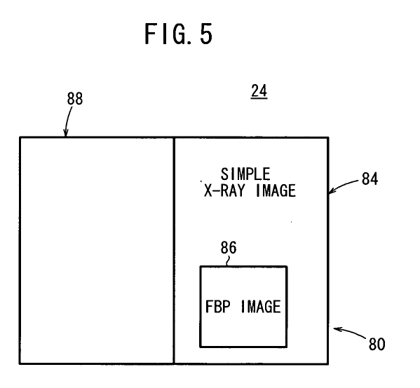

The frame display format is a format for displaying the frame of an area of interest in a single image and displaying an image different from the single image in the frame. FIG. 5 shows a simple X-ray image displayed fully in an image display area 84 on the screen 80 of the display unit 24, and an FBP image displayed in an area 86 of interest within the image display area 84. The area 86 of interest may be moved to any desired position based on a command entered through the input unit 22. The display area of the screen 80 except for the image display area 84 is a character information display area 88 for displaying character information.

Irrespective of which one of the single image display format, the parallel image display format, or the frame display format is selected, the display controller 62 sets the number of images to be displayed and an image display area based on the preset display settings, and associates the coordinates of the image display area and the coordinates of the image or images to be displayed with each other.

In step S13, the display controller 62 confirms a preset display magnification. The display magnification represents which range of each image is to be displayed in the image display area, i.e., a display magnification of each image on the screen 80 of the display unit 24. The display magnification is defined by vertical and horizontal lengths (dots) of each image to be displayed in the image display area on the screen 80 of the display unit 24. In the present embodiment, if the parallel image display format or the frame display format is selected, then a plurality of images to be displayed have a common display magnification. When the common display magnification is changed, then all the images are displayed at the changed common display magnification. Specifically, the display controller 62 associates the coordinates of the divided image display areas 82 with each other, and changes the ranges of the images displayed in the respective divided image display areas 82 according to the changed common display magnification.

In step S14, the display controller 62 specifies a preset display range. The display range represents which range of each image is to be displayed, for example. The display range is defined by the coordinates of each pixel included therein or the coordinates of particular pixels (e.g., the pixels at the four corners of the display range). If the display range fully covers an image, then the image is displayed in its entirety. However, if the display range covers a portion of an image, then the displayed portion of the image can be scrolled by changing the display range.

In step S15, the display controller 62 performs a preset image correcting process. The image correcting process may be a gain adjusting process (sensitivity correcting process), an offset adjusting process (gradation correcting process), an edge emphasizing process (frequency emphasizing process), and a reversing process (shade reversing process). If the data of a plurality of images are input to the display controller 62, then the display controller 62 performs the image correcting process on each of the images. It is possible for the display controller 62 to perform the gain adjusting process on a simple X-ray image and to perform the edge emphasizing process on an FBP image, for example.

In step S16, the display controller 62 outputs a signal (image signal Si) representing an image or images (image display area or areas) generated by the processing of steps S11 through S15, to the display unit 24. When the display unit 24 receives the image signal Si, the display unit 24 displays an image or images based on the image signal Si.

### 3. Advantages of the Present Embodiment

According to the present embodiment, the radiation image diagnosing system 10 can display a shift-and-add image and an FBP image parallel to each other. Therefore, the doctor 70 can view both the shift-and-add image and the FBP image at one time, and hence can diagnose the subject 26 efficiently.

According to the present embodiment, furthermore, the radiation image diagnosing system 10 can display a simple X-ray image and at least one of a shift-and-add image and an FBP image parallel to each other. Therefore, the doctor 70 can view a combination of the simple X-ray image and the shift-and-add image, a combination of the simple X-ray image and the FBP image, a combination of the shift-and-add image and the FBP image, or a combination of the simple X-ray image, the shift-and-add image, and the FBP image at one time, and hence can diagnose the subject 26 efficiently.

According to the present embodiment, furthermore, the radiation image diagnosing system 10 can display a shift-and-add image or an FBP image in the area 86 of interest within the simple X-ray image displayed in the image display area 84. Therefore, a shift-and-add image or an FBP image can be displayed in the area 86 of interest against the background of the displayed simple X-ray image. As a result, the doctor 70 can diagnose the subject 26 with increased convenience.

According to the present embodiment, furthermore, the radiation image diagnosing system 10 can perform the image correcting process separately on a simple X-ray image, a shift-and-add image, and an FBP image. Therefore, the radiation image diagnosing system 10 is capable of handling images where the image correcting process is effective with respect to only one of a simple X-ray image, a shift-and-add image, and an FBP image.

According to the present embodiment, furthermore, the radiation image diagnosing system 10 can display a simple X-ray image, a shift-and-add image, and an FBP image in relation with each other for the doctor 70 to compare the simple X-ray image, the shift-and-add image, and the FBP image with each other. Therefore, the doctor 70 can diagnose the subject 26 more efficiently.

### B. Modifications

The present invention is not limited to the illustrated embodiment described above, but various changes and modifications may be made to the embodiment of the invention. Examples of such changes and modifications will be described below.

In the illustrated embodiment, the radiation source 12 and the radiation conversion panel 30 are moved synchronously in respective opposite horizontal directions (to the left and right in FIG. 1). However, as disclosed in U.S. Patent Application Publication No. 2002/0154728, the radiation source and the radiation conversion panel may be fixed to an arcuate joint member, and the arcuate joint member may be rotated to move the radiation source and the radiation conversion panel in synchronism with each other.

In the illustrated embodiment, the tomosynthesis image capturing assembly 32 operates in the tomosynthesis image capturing mode and the simple X-ray image capturing mode. However, a separate radiation image capturing system may be employed to operate in the simple X-ray image capturing mode.

In the illustrated embodiment, the radiation image diagnosing system 10 can display three images, i.e., a simple X-ray image, a shift-and-add image, and an FBP image. However, the radiation image diagnosing system 10 may be arranged to display only two of the above three images or to display an image or images other than the above three images.

In FIG. 4, the images are displayed parallel to each other in a horizontal array. However, the images may be displayed parallel to each other in a vertical array.

In the illustrated embodiment, the image processor 42 is shown as having the four separate memories, i.e., the first memory 50, the second memory 52, the third memory 56 and the fourth memory 60. However, the image processor 42 may have a single memory including memory areas corresponding to the above four memories.

Although certain preferred embodiments of the present invention have been shown and described in detail, it should be understood that various changes and modifications may be made therein without departing from the scope of the appended claims.

What is claimed is:

1. A radiation image diagnosing system comprising:
a tomosynthesis image capturing assembly for applying a radiation from a radiation source to a subject at a plurality of different angles, detecting the radiation which has passed through the subject with a radiation conversion panel, and capturing a plurality of tomosynthetic sectional images;
a shift-and-add processor for processing the tomosynthetic sectional images to reconstruct a shift-and-add image according to a shift-and-add process;
a filter back projection processor for processing the tomosynthetic sectional images to reconstruct a filter back projection image according to a filter back projection process;
a display unit; and
a display controller for controlling the display unit to display the shift-and-add image and the filter back projection image parallel to each other thereon.

2. A radiation image diagnosing system according to claim 1, further comprising:
a simple X-ray image capturing unit for plain radiography, arranged to acquire a simple X-ray image;
wherein the display controller controls the display unit to display the simple X-ray image and at least one of the shift-and-add image and the filter back projection image parallel to each other thereon.

3. A radiation image diagnosing system according to claim 2, wherein the display controller associates coordinates of the simple X-ray image and coordinates of the at least one of the shift-and-add image and the filter back projection image, controls the display unit to display a frame of an area of interest in the displayed simple X-ray image, and controls the display unit to display the shift-and-add image or the filter back projection image which corresponds to the displayed simple X-ray image within the frame of the area of interest.

4. A radiation image diagnosing system according to claim 1, wherein the display controller performs an image correcting process separately on the shift-and-add image and the filter back projection image.

5. A radiation image diagnosing system according to claim 1, wherein when the display controller enlarges or reduces one of the shift-and-add image and the filter back projection image or changes a display range of the one of the shift-and-add image and the filter back projection image, the display controller also enlarges or reduces the other of the shift-and-add image and the filter back projection image or changes a display range of the other of the shift-and-add image and the filter back projection image.
